(19) United States
(12) Patent Application Publication
(10) Pub. No.: US 2003/0028361 A1
(43) Pub. Date: Feb. 6, 2003

(54) Computer program and method for simulating physical instruments

(76) Inventor: Daniel W. Nelson, Rochester, MN (US)

Correspondence Address: BRIGGS AND MORGAN, P.A., 2400 IDS CENTER, MINNEAPOLIS, MN, 55402, US

(21) Appl. No.: 10/191,001

(22) Filed: Jul. 8, 2002

Related U.S. Application Data
(60) Provisional application No. 60/307,491, filed on Jul. 24, 2001.

(51) Int. Cl. G06G 7/48

(52) U.S. Cl. 703/6

(57) ABSTRACT

The invention consists of computer simulated instruments that interact with a simulated environment for the purposes of measurement and manipulation of that environment. Game programs may make use of various combinations of these instruments to create intellectually stimulating play involving mathematics, physical science, and art (when the tools are used for creative manipulation of an environment to create pictures or structures).

### BACKGROUND OF THE INVENTION

The present invention relates to a computer program and method for simulating physical instruments that interact with a simulated environment for the purposes of measurement and manipulation of that environment. Game programs may make use of various combinations of these instruments to create intellectually stimulating play involving mathematics, physical science, and art (when the tools are used for creative manipulation of an environment to create pictures or structures).

### SUMMARY OF THE INVENTION

A computer program executable on a computer having a processor, a display, a keyboard, and a mouse, for graphically simulating a variety of physical measuring instruments on the display.

A method for graphically simulating a variety of physical measuring instruments on a display, comprising the steps of:

(a) displaying the simulated physical measuring instruments as icons on a display;

(b) waiting for the operator to select an icon;

(c) activating the simulated physical measuring instrument corresponding to the user-selected icon;

(d) applying a simulated force to the active simulated physical measuring instrument; and

(e) monitoring changes in the the active simulated physical measuring instrument as a result of the simulated applied force.

Examples of simulated instruments covered by this patent include the following:

pendulum timer

balance

tape measure

surveyor tool

object launcher

Two computer games are described that are constructed using the method of the present invention.

The determination of gravity is included as an example of how the measurement instruments may be used together to synthesize information regarding a simulated environment.

### BRIEF DESCRIPTION OF THE DRAWINGS

FIG. 1 is a schematic of a computer-simulated pendulum timer of the present invention.

FIG. 2 is a schematic of a computer-simulated balance of the present invention.

FIGS. 3a and 3b are schematics of a computer-simulated tape measure of the present invention.

FIG. 4 is a schematic of computer-simulated surveyor tool and object launcher of the present invention.

FIG. 5 is a schematic of the use of the computer-simulated instruments of the present invention to launch a dart over a portcullis to hit a switch to raise the portcullis.

FIG. 6 is a schematic of the use of the computer-simulated instruments of the present invention to construct objects from parts.

FIGS. 7a-7d arc schematics of the use of the computer-simulated instruments of the present invention to determine the gravity constant using Atwood's machine.

FIG. 8 is a block diagram of a computer used to implement the computer-simulated instruments of the present invention.

FIGS. 9a-9e are flowcharts of a computer program that implements the computer-simulated tools of the present invention.

### DETAILED DESCRIPTION OF THE PREFERRED EMBODIMENTS

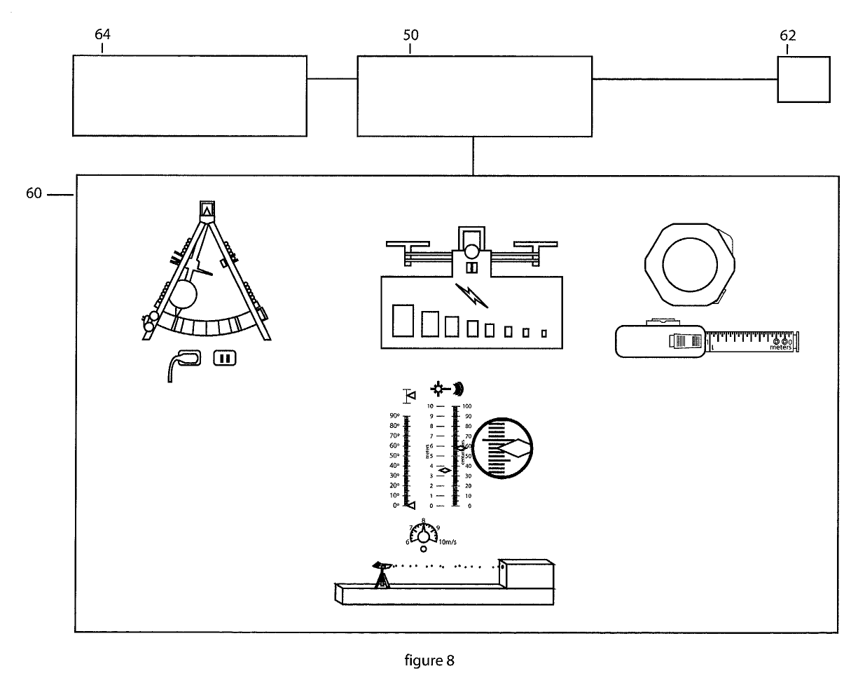

In the preferred embodiment of the invention, (FIG. 8) the invention requires a processor 50 executing a computer program to cause the various computer-simulated instruments to be displayed on a display means 60, such as a CRT, monitor, flat panel display, LCD display, or the equivalent. The computer-simulated instruments are two-dimensional graphic objects displayable at various points on the display means 60.

Each instrument functions independently of the others and may be included in program variations in which other instruments here mentioned may or may not appear.

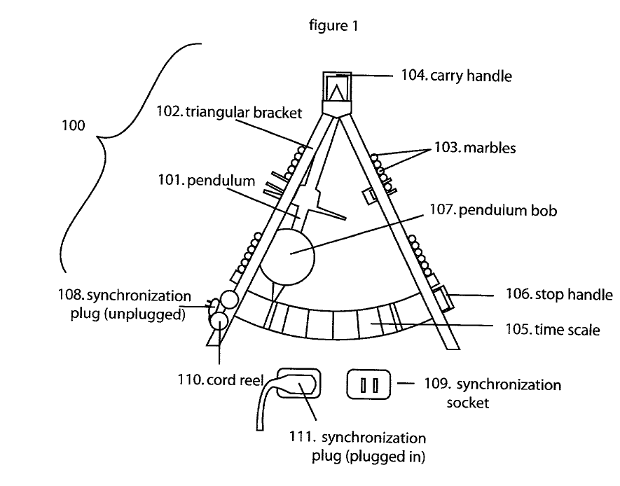

Measurement of Time: The Pendulum Timer (FIG. 1)

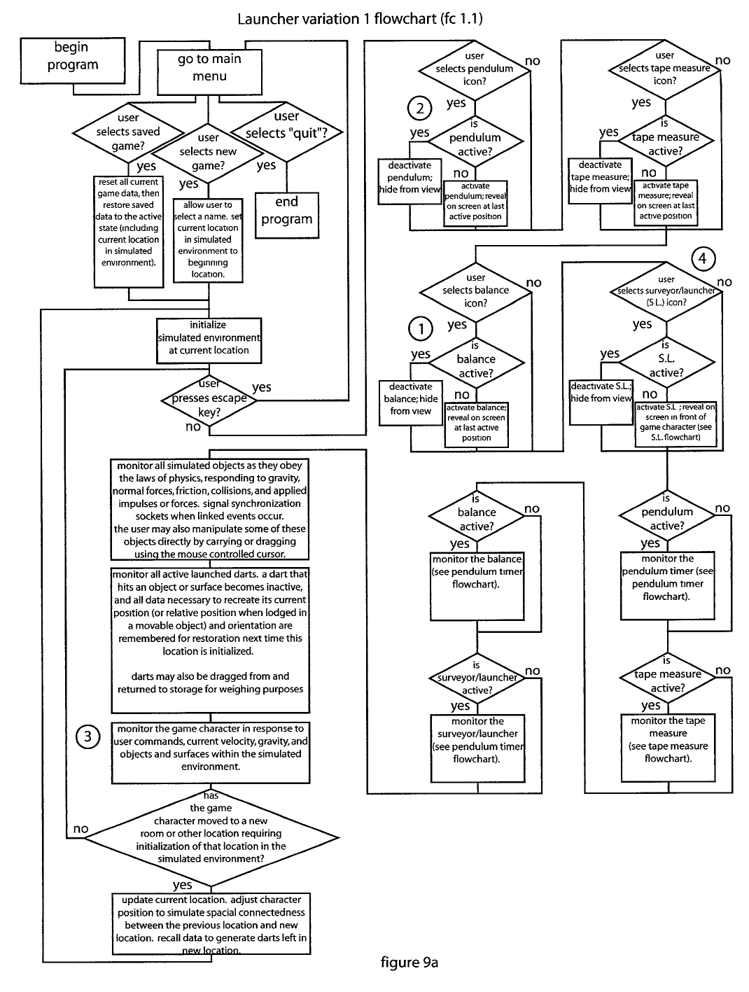

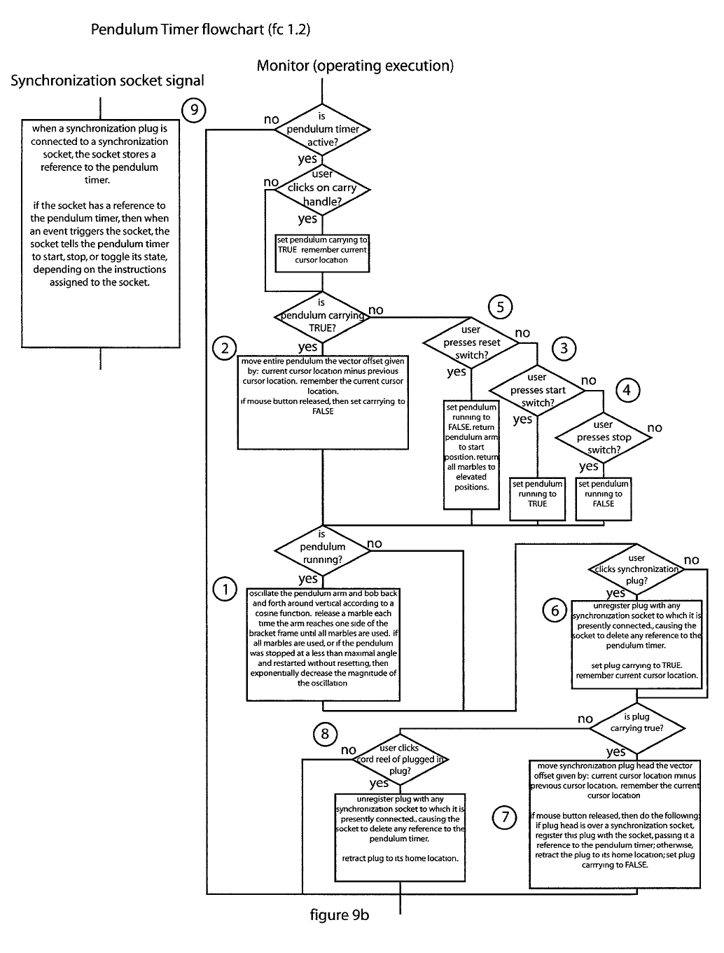

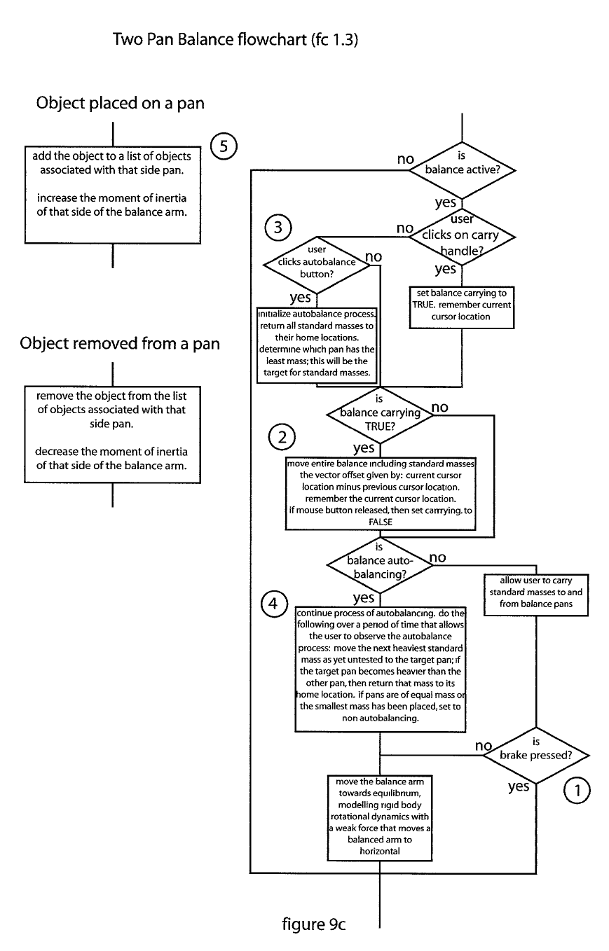

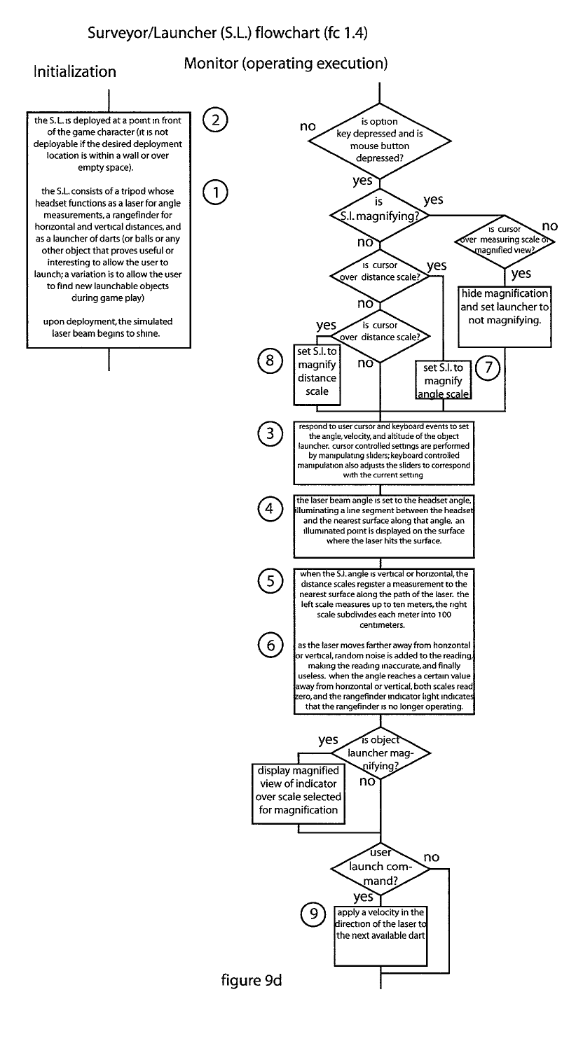

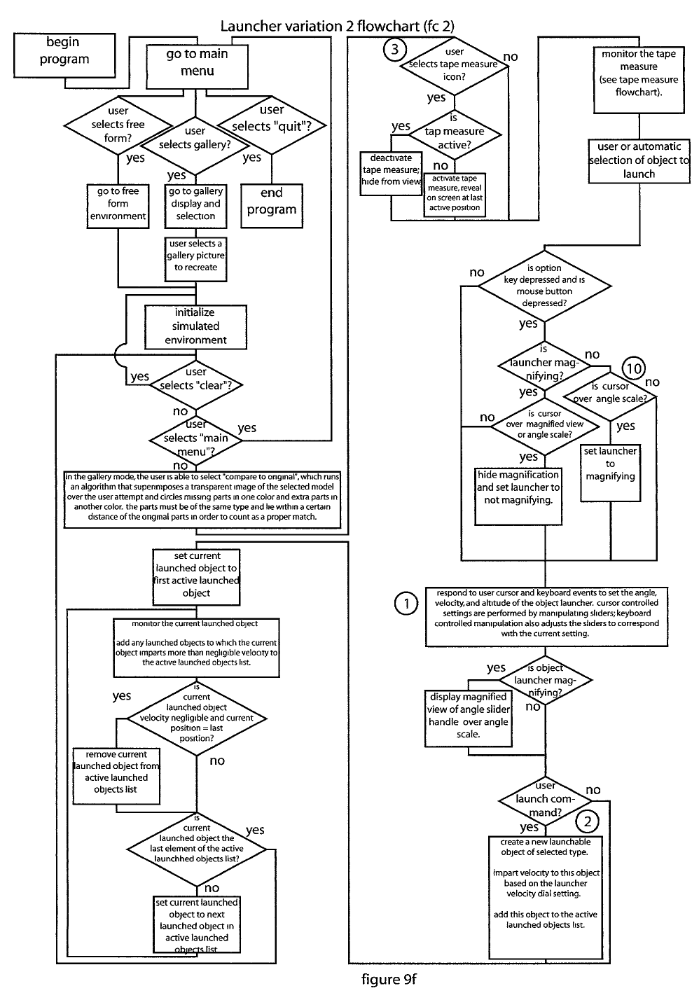

Clicking an icon representation of the pendulum timer causes the pendulum timer 100 to be revealed if it was hidden and to be hidden if it was revealed (flowchart FIGS. 9a-9e) (hereafter referred to as fc 1.1-1). The pendulum is revealed at its last active location.

Time is measured by a pendulum (101) in a triangular bracket (102) that releases one marble (103) from one of two stacks every time it reaches either side of the triangle (fc 1.21). The pendulum can be repositioned on the screen by dragging its carry handle (104) (fc 1.2-2) so as not to cover objects with which it must interact. It may be started and stopped by clicking the curved time scale (105) (fc 1.2-3) along the bottom and may also be stopped by clicking the handle to the right (106) (fc 1.2-4). It is reset by clicking the pendulum bob (107) (fc 1.2-5). Additionally, two synchronization plugs (108) allow the pendulum to start and stop synchronically with events on the screen, as described below.

The pendulum timer represents a mechanism for measuring time by counting marbles. The theoretical idea behind the functioning of the mechanism is that the falling marbles give energy to the pendulum arm, but take none since they are not carried with the arm, so that the pendulum maintains a consistent maximum angle of oscillation as long as marbles remain in the raised position. After the last marble falls, the magnitude of pendulum oscillation exponentially decays (fc 1.2-1).

The pendulum can be started and stopped in two ways. The most direct way is to click the handles described above (105 & 106). The more useful means is to use one or both of the synchronization plugs (108). These plugs can be used to toggle the state of the pendulum from off to on and from on to off when a specific event occurs (fc 1.2-9). The synchronization plugs operate by using the mouse controlled cursor to drag a plug (fc 1.2-6) from its rest location and to release it over a synchronization socket (109) (fc 1.2-7). The plug may be retracted by clicking on its cord reel (110) (fc 1.2-8) or by grabbing the plug from its active location (111) (fc 1.2-6) and releasing it while not over a synchronization socket (fc 1.2-7).

When a plug is being dragged, it appears as a plug with a cord connected to the pendulum at its home location. When the plug is plugged into a receptacle, the cord connecting it to its home location disappears; the plug is replaced by a graphic located at the receptacle representing its plugged in state (111).

The amount of time measured by each marble may be defined for the user or left undefined. If undefined, then it is left to the user to ascribe consistent meaning to time measurements. If defined, then the program should explain the time value of each marble and of each subsection of the time scale. The tick marks along the time scale subdivide the fraction of time taken by one marble. The number of ticks may be altered, as may the time measured by each marble.

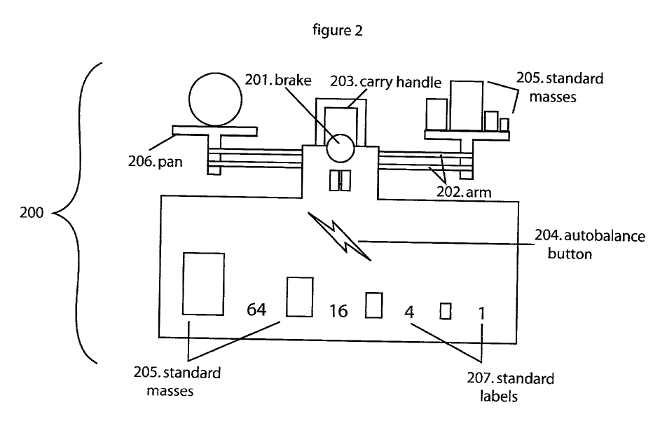

Measurement of Mass: The Balance (FIG. 2)

Clicking an icon representation of the balance causes the balance to be revealed if it was hidden and to be hidden if it was revealed (FIG. 9a fc 1.1-2). The balance is revealed at its last active location.

The balance 200 is a two pan balance with a set of standard masses. A brake (201) operates so long as it is clicked, serving to temporarily stop the oscillation of the arm (202) (fc 1.3-1). The balance can be repositioned on the screen by dragging it by its handle (203) (fc 1.3-2). Pressing the auto-balance button (204) (fc 1.3-3) causes the balance to automatically weigh an object, a process that occurs visually (fc 1.3-4) to show users its algorithm instead of acting as a black box.

The balance is used to compare objects of unknown mass against its standard masses (205) or against one another. An object can be placed on either balance pan (206) by releasing it over the desired pan (fc 1.3-5). The standard masses can be manipulated by dragging with the cursor (fc 1.3-6), or by clicking the auto-balance button (204) (fc 1.3-3). Clicking auto-balance returns all standard masses to their home positions, then begins weighing the unknown object against each mass from the most to least massive, leaving the mass on the balance if the side with the standards is lighter than the unknown, returning it if that side is heavier (fc 1.3-4). At the end of the auto-balance algorithm, the mass of the object is determined to a precision equal to the smallest available standard mass. Auto-balance also works in situations in which both pans are loaded, placing standard masses on the side with the least initial mass.

The decimal value in grams (or any other fictitious or existing mass standard) of each standard mass is labeled (207) on the balance body behind each standard mass, so that when a particular standard is on one of the pans, the numerical value of its mass is revealed. Each of the standard masses has a mass equal to half the mass of the next largest mass. By assigning a value of one to the smallest standard mass, the empty spaces along the standard storage shelf form the binary places of a base two number. When an object is perfectly balanced against standard masses, its base ten mass can be read by summing the numbers from every space on the standards shelf that is unoccupied by a mass (in FIG. 2, the ball on the left pan has a mass of 64+16+4+1=85 standard mass units). This is a subtle means of introducing the user to base two without drawing attention to the process.

Alternatively, the masses may follow the more conventional base ten system, supplying the user with a combination of masses that will allow for measurement of all combinations between the least precision and the greatest mass required to meet the needs of any particular simulated environment.

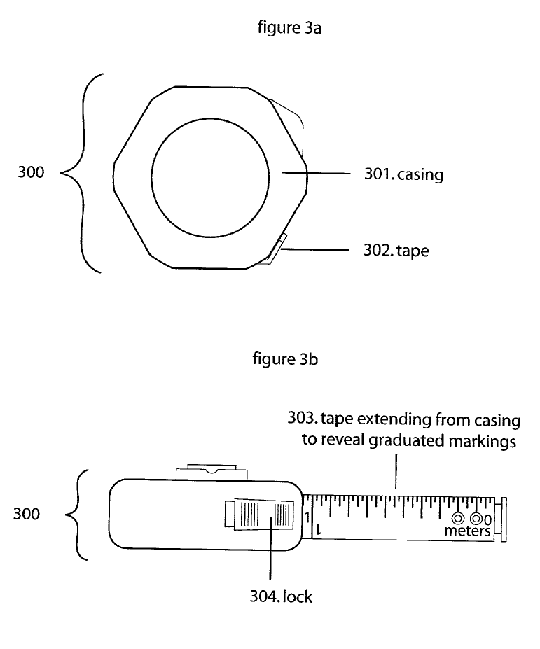

Measurement of Distance and Length: Tape Measure (FIG. 3)

Clicking an icon representation of the tape measure (fc 2-3) causes the tape measure 300 to be revealed if it was hidden and to be hidden if it was revealed. The tape measure is revealed at its last active location in its last active mode; that is, if the tape was extended when the tape measure was hidden, then the tape remains extended when the tape measure is revealed.

The tape measure may be used to measure width and height of objects or to measure the distance between points within an environment. A side view (FIG. 3a) of the tape measure 300 casing (301) is the initial view of the tape measure. Grabbing the tape (302) (fc 2-4) causes the view to changed to a top view (FIG. 3b) and the tape to extend from the casing (303). The tape can be dragged in and out of the casing, and the tape measure can be rotated so that the tape measures left, right, up, or down (fc 2-5). The tape is marked with graduated lines and labeled to denote units of length and subdivisions of the units of length; the tape pictured in FIG. 3b is labeled in meters. The tape measure may be repositioned on the screen by clicking its casing (fc 2-6) and dragging (fc 2-7) while in either the side view or the top view.

The tape lock (304) may be pressed (fc 2-8) to cause the tape to retract. Clicking this lock again stops the retraction. The tape measure returns to a side view after the tape finishes retracting (fc 2-9).

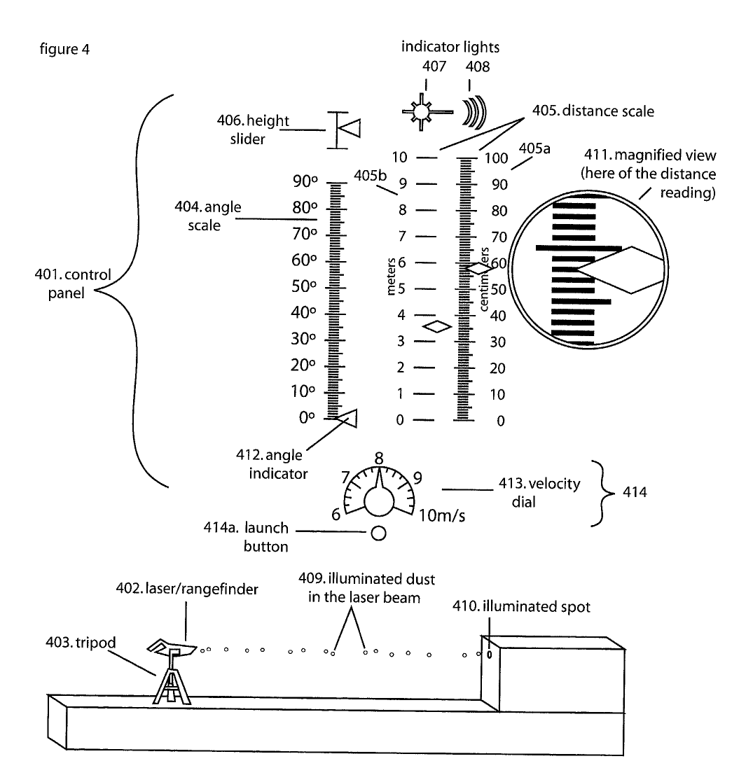

Measurement of Distance: Surveyor Instrument (FIG. 4)

The surveying instrument consists of a control panel (401) and a laser/rangefinder (402) that sits atop a tripod (403) (fc 1.4-1). The surveyor control panel includes an angle scale (404), a distance scale (405), a height slider (406), and lights indicating laser operation (407) and rangefinder operation (408). The surveyor tool is deployed immediately in front of the game character (fc 1.4-2). A user moves the game character through a simulated environment (fc 1.1-3) to a position from which it is beneficial to use the laser, the rangefinder, or both, and clicks on the surveyor tool icon (fc 1.1-4) to deploy the surveyor instrument tripod and to reveal the surveyor instrument control panel. The tripod will not deploy into a solid surface or over empty space in the simulated environment (fc 1.4-2).

The angle scale is 404 a graduated scale with ninety-one marks, with every fifth mark being longer and every tenth mark being longer still, allowing for measurement of angles between horizontal and straight up. The angle indicator (412) may be grabbed and manipulated using the mouse, or it may be controlled using up and down on the keyboard; holding ‘shift’ increases the rate of change (fc 1.4-3) (fc 2-1). A laser beam (fc 1.4-4), which may be depicted by illuminated points (as of airborne dust) (409), or by a solid line, each with a bright spot on the impacted surface (410), or by just the bright spot, gives a visual representation of the point at which the surveyor instrument is aiming for any given measurement. The laser may be projected into a simulated three-dimensional space or may remain in the plane of the screen.

Distance measurement relies on two scales 405 to measure distance precisely over a wide range of distances. The left scale is divided into meters, with one mark per meter. The right scale 405a is divided by one hundred one marks, with every fifth mark being longer and every tenth mark being longer still. The right scale refines the measurement of each meter on the left scale 405b, so that combined, the scales can measure accurately to the nearest centimeter or half centimeter over as many meters as are measurable on the left scale (the distance scale pictured here can measure up to ten meters). Distance is measurable when the rangefinder aims horizontally or vertically (fc 1.4-5). As the laser moves farther away from horizontal or vertical, random noise is added to the reading, making the reading inaccurate, and finally useless (fc 1.4-6). When the angle reaches a certain value away from horizontal or vertical, both scales read zero, and the rangefinder indicator light indicates that the rangefinder is no longer operating.

The height slider 406 raises and lowers the tripod headset 402 (fc 1.4-3) (fc 2-1). While this slider is being moved, the distance reading drops to zero, the laser turns off, and the indicator lights turn grey. Operation resumes when the height slider handle is released.

If a user clicks on the angle scale 404 while holding down an option key, then a magnified view 411 of the angle scale indicator over the angle scale is displayed (fc 1.4-7) (fc 2-10). The graduated markings allow the user to consistently read the magnified view to the nearest degree (or half degree by estimating). Corresponding functionality is available by option clicking the distance scale (411) (fc 1.4-8), giving consistently accurate reading to the nearest centimeter (or half centimeter).

Interaction With the Environment at a Distance: Object Launcher (FIG. 4) The object launcher 414 may be included as part of the surveyor tool or may be an independent device. If not built into the surveyor instrument, then the distance scales and the indicator lights are omitted from the launcher control panel. The object launcher 414 is used to precisely place launched objects by using an understanding of projectile motion physics to ascertain what measurements need to be made, making these measurements using other tools described in this patent (such as the surveyor tool or the tape measure), and using these measurements to compute the angle and velocity at which to launch. The angle and altitude settings are made as outlined in the surveyor tool description, and the velocity is controlled by a dial (413), which can be rotated by clicking and dragging with the mouse cursor or by using the keyboard (fc 1.4-3) (fc 2-1). The velocity control may alternatively be a non-rotational slider or other control. An object is launched by pressing the button (414a) below the velocity dial or by pressing the space bar on the keyboard (fc 1.4-9) (fc 2-2).

The general object launcher can be specified in two ways. The first variation is used to interact with the environment from a distance, for hitting targets unreachable from the game character location (flowcharts 1 & 1.4). The second function is to arrange objects in relation to one another to create a structure or picture (flowchart 2).

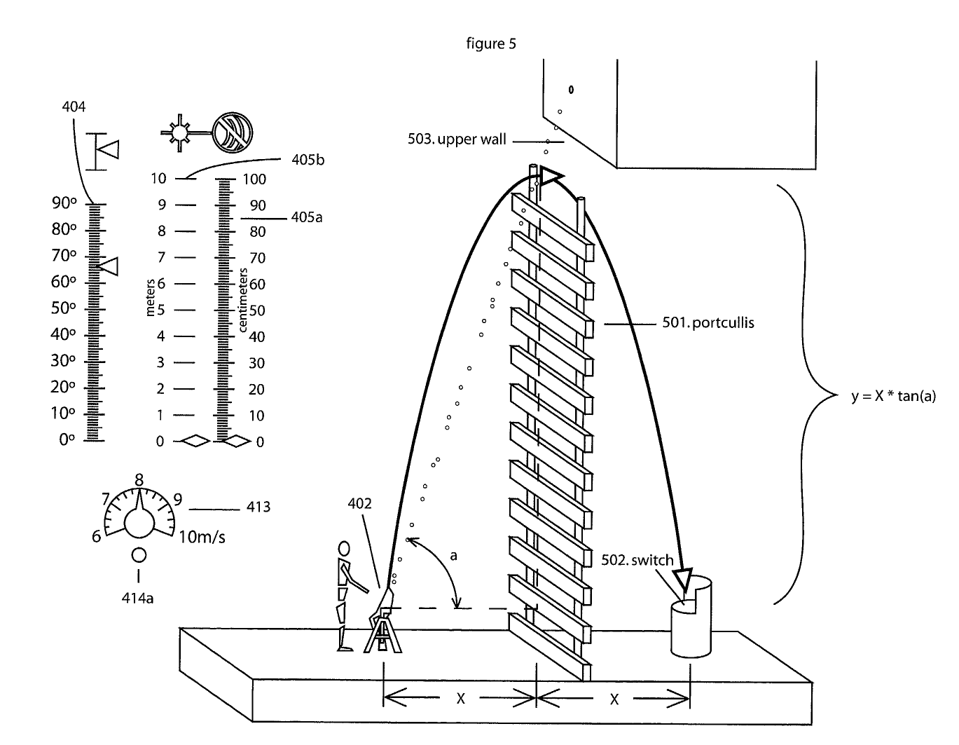

### EXAMPLE 1: (FIG. 5)

FIG. 5 illustrates an example of launcher usage to interact with the environment from a position unreachable by the game character. In this figure, the game character's progress is blocked by a portcullis (501), which is electrified, preventing the character from climbing over or through it. To open the portcullis, the user must launch a dart into a switch (502) on its far side. Darts stuck in the top of the portcullis or in the upper wall (503) are not retrievable, so trial and error is not a good solution. To precisely hit the switch in one attempt, the user may do the following:

Measure the distance to the front and back of the switch 502 by lowering and raising the altitude of the rangefinder headset 402, and take the average of these to determine the distance to the middle of the switch.

Measure the distance to the portcullis 501 by setting the headset altitude to a middle value so that the laser beam impacts one of the bars of the portcullis.

Subtract the distance to the portcullis 501 from the distance to the middle of the switch 502 to find the distance from the portcullis to the middle of the switch—call this distance ‘x’—then move the game character until the location at which it deploys the rangefinder is approximately this distance from the portcullis. Now the portcullis 501 is close to halfway between the rangefinder/launcher and the middle of the switch.

Increase the angle of the surveyor headset 402 until the laser is passing through space either just above the portcullis 501 or through the space between two bars of the portcullis. Note this angle using the magnified view of the angle indicator. Call this angle ‘a’.

The height to this point is given by ‘x*tangent(a)’ (let all trigonometry functions in these examples take degrees, and let all inverse trigonometry functions return degrees). Call this ‘y’.

We now have point(x, y) as the top of the arc through which we want to launch a dart.

At the top of its path, an object in freefall has zero vertical velocity (y-axis velocity, call this Vy), so (Vyfinal=Vyinitial−gravity*time) gives (time=Vyinitial/gravity).

Substitute this for ‘t’ in (y=Vyinitial*t−1/2*gravity*timeˆ 2) to get (y=Vyinitial*(Vyinitial/gravity)−1/2*gravity*(Vyinitial/gravity)ˆ 2), which gives (y=Vyinitialˆ 2/gravity−1/2*Vyinitialˆ 2/gravity), which in turn gives (y=1/2 Vyinitialˆ 2/gravity=Vyinitialˆ 2/(2*gravity)), leaving Vyinitial=square root(2*y*gravity), where ‘y’ was calculated in step v.

The x-axis velocity ‘Vx’ remains constant throughout the flight since there is no force acting against the dart along this axis while the dart is in flight (we neglect air resistance). ‘Vx’ is given by (Vx=x/time) where ‘x’ was measured in step iii.

Now that we have Vx and Vy, we can set the velocity and the angle of the dart launcher by using rules of trigonometry. The velocity (V) to which we set the velocity dial is given by recalling the Pythagorean theorem, in which the magnitude of the hypotenuse of a right triangle, ‘c’ is given by (cˆ 2=aˆ 2+bˆ 2) which gives (c=square root(aˆ 2+bˆ 2)). Here, (c=V), (a=Vx), and (b=Vy), so (V=square root(Vxˆ 2+Vyˆ 2)). The angle to which we set the launcher is given by (launch angle=arctan(Vy/Vx)). Setting the velocity dial and the launcher angle to the values given by these calculations will place the dart into the middle of the switch on the far side of the portcullis.

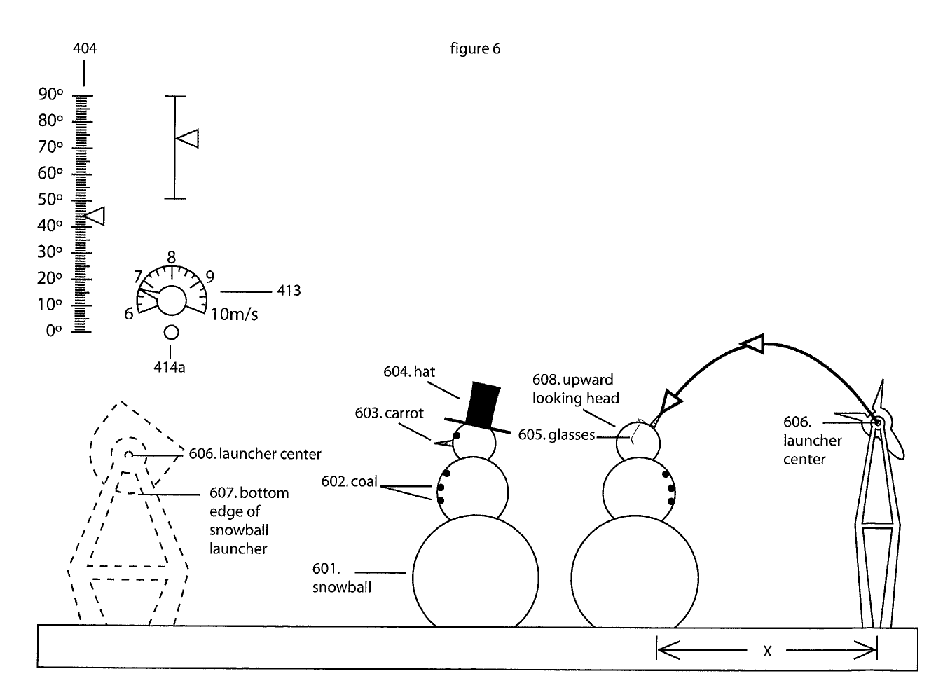

### EXAMPLE 2: (FIG. 6)

FIG. 6 illustrates the use of the object launcher as a means of constructing pictures using physics. For such usage, the horizontal position of the launcher 606 is limited to two positions, one facing right from the left side of the screen, the other facing left from the right side of the screen. In this example, the user is attempting to create snowpeople by launching snowballs (601), coal (602), carrots (603), hats (604), glasses (605), hair, and any other objects that might prove interesting in creating snowpeople pictures.

The surveyor instrument is not incorporated into the object launcher in this example, so all horizontal and vertical measurements are measured directly using the tape measure. For all trajectories, ‘x’ will be measured as the distance from the center of the object launcher (606) to the desired horizontal resting position of the center of the launched object.

Certain of the launchable objects, such as snowballs 601 in this example, are to be stacked on top of one another. This requires the path of flight to be a full parabolic curve so that the object is moving downwards when it reaches the desired destination. In contrast to the portcullis example above, for this path of flight, there is no particular height that the snowball 601 needs to reach at the peak of its curve. Instead of choosing a maximum height, the user selects the desired angle at which the launched object should be moving when it returns to the height of the launcher on its downward path. This angle should be fairly great, say larger than sixty degrees, so that the moving object does not slide off of the object on which it is being placed. Call this angle ‘a’. Note that if ‘a’ is too great, then the velocity given by the computation will be greater than the capacity of the launcher, and a smaller ‘a’ must be selected. The necessary computation can then be derived as follows:

We know that (Vyfinal=Vyinitial−gravity*time). At the peak of its trajectory, the launched object will have zero vertical velocity, so this becomes (time =Vyinitial/gravity).

(Vx=(x/2)/time) where ‘x’ was measured above as the distance from the launcher center to the desired horizontal location; divide ‘x’ by two because the peak of the trajectory will be halfway between the launch location and the destination location.

Substitute the expression for ‘time’ from step i into the equation in step ii to get (Vx=(x /2)* gravity/Vy).

Angle ‘a’, the launch angle, is known, and the launch angle relates to the launch velocity components by (tangent(a)=Vy/Vx). Substituting the expression for ‘Vx’ in step iii gives (tangent(a)=Vyˆ 2/((x/2)*gravity)), which can be solved for ‘Vy’ as the following: (Vy=square root((x/2)*gravity*tangent(a))).

We thus have an expression for ‘Vy’ in terms of known and measurable quantities, and we have an expression for ‘Vx’ in terms of ‘Vy’ and known and measurable quantities. The launch velocity is then (V=square root(Vxˆ 2+Vyˆ 2)).

To launch the snowball onto the desired location, set the launch velocity dial 413 to ‘V’, calculated in step v above, and set the launch angle 404 to ‘a’, which was chosen above. Note that for objects that stack on top of one another, such as snowballs, it is important to adjust the launcher height so that the bottom of the snowball when it is launched, is aligned to the lowest edge of the desired final location of the snowball. This may be achieved by extending the tape measure horizontally and placing its top edge against the point to be reached by the bottom of the snowball and adjusting the launcher height so that the bottom of the launcher (606) just touches the top of the tape. For objects that are placed on top of other objects, but that do not themselves stack, such as hats, the center of the launcher should be aligned with the final vertical location.

Other launchable objects, such as coal and carrots, are to be placed at a certain vertical point in the surface of a snowball (402, 403). This requires a similar calculation to that in the portcullis challenge in that now we are trying to hit a particular height at a particular horizontal distance from the launcher. These objects are treated as points, rather than as having area or volume, so horizontal and vertical distances are measured from the launcher center to the point on the snowball into which we want to lodge the object. The launcher is lowered below the target height, and ‘y’ is the vertical distance from the center of the launcher to the desired location. ‘y’ may be calculated by extending the tape measure vertically from the ground to the launcher center, then from the ground to the destination location, and taking the difference between the two measurements.

Certain objects, such as carrots, lodge into a snowball at the angle with which they impact the snowball. When such objects 303 are desired to protrude horizontally from the snowball (601), the second computation will suffice, since at the top of its arc, the carrot has no vertical velocity and is therefore pointing with its bulbous end facing directly in the direction of its horizontal velocity. However, it may also be desired to control the angle at which these objects lodge into a snowball. This allows creation of upward looking figures (608) and other variations. In such cases, we return to the point of view of trying to set one object on top of another, in which the launch angle was selected, for this will also be the angle at which the launched object returns to its launch height. The difference here is that we align the center of the launcher 606 with the impact height instead of the bottom of the launcher, and lower angles may be selected since the smaller mass of these objects will not slide off as easily as the larger mass snowballs.

### EXAMPLE 3

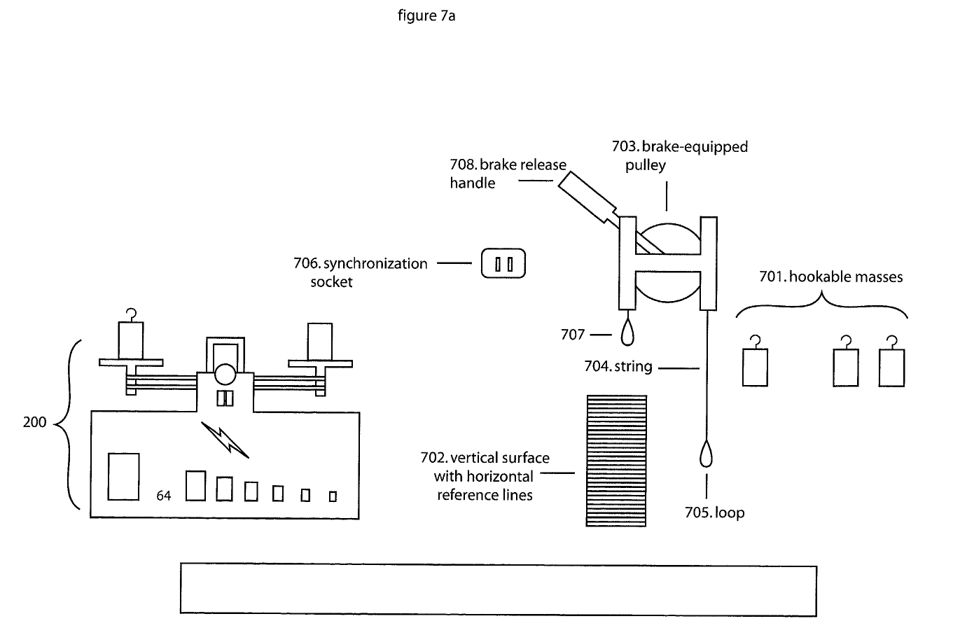

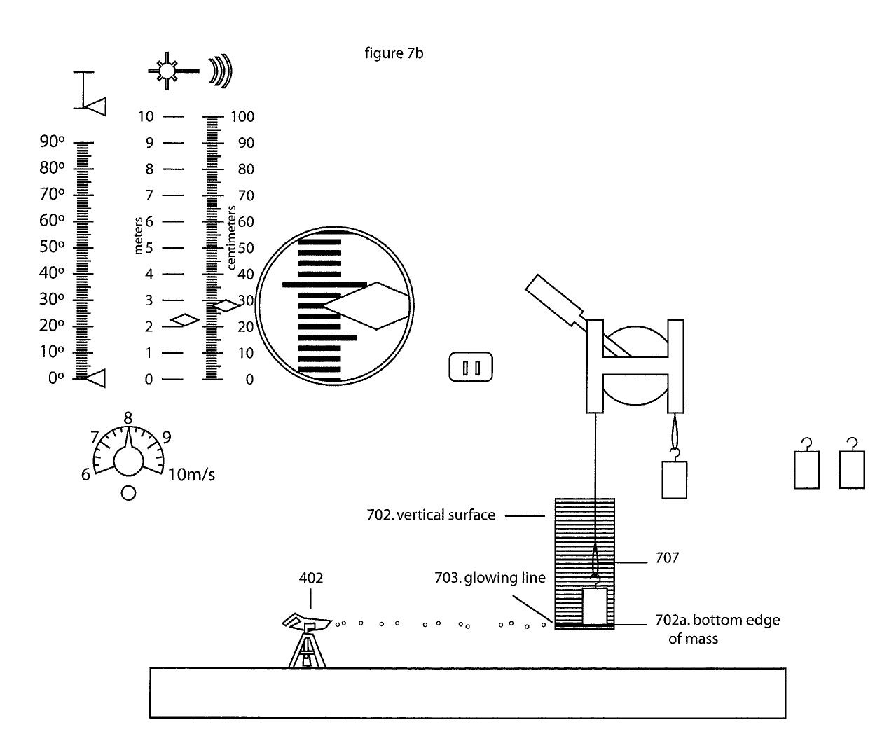

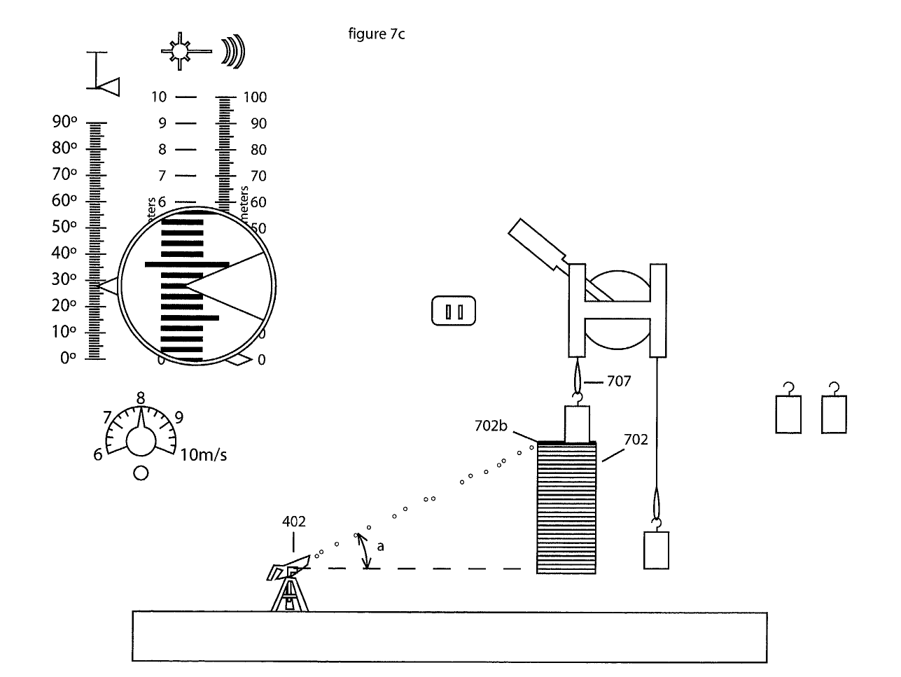

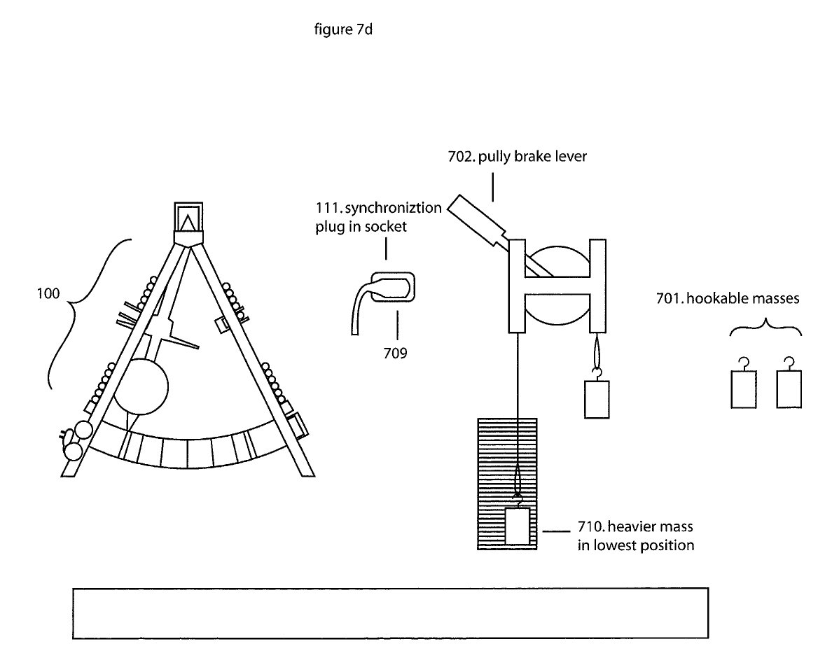

### Determination of the Gravity Constant Using Atwood's Machine (FIG. 7)

Provide the following:

Several hookable masses (701) of different mass

A vertical surface with horizontal reference lines (702) which can be used in conjunction with the surveyor tool to measure the distance traveled by the falling mass.

A brake-equipped pulley (703) with a string (704), at each end of which is a loop (705).

A synchronization socket (706) to start the pendulum timer 100 when the brake is pulled and to stop the pendulum timer when one of the hooks reaches its lowest possible point.

Determine gravity as follows:

Use the balance 200 to determine the mass of two different, hookable masses 701 (FIG. 7a).

Hang the more massive mass from the loop 707 whose traveling distance can be measured and the less massive mass from the other loop (705).

Determine the distance that will be traveled by the falling mass:

(FIG. 7b) deploy the surveyor tool and measure the distance to the vertical surface (701). Call this distance ‘x’.

Pull the loop with the heavier mass (707) to its lowest point, and adjust the altitude of the surveyor headset 402 so that the laser impacts the vertical surface 702 at the bottom edge of the hookable mass (702a). The experiment is designed so that this lower edge exactly aligns with one of the horizontal lines on the vertical surface 702. These lines illuminate when struck by the laser (703), so the user can be certain that the laser headset is at the correct altitude when the correct line glows. (FIG. 7c) pull the loop 707 with the heavier mass to its highest point.

Increase the surveyor angle until the laser 402 illuminates the line 702b adjacent to the bottom of the hanging mass in its highest position. Measure this angle, calling it ‘a’. The distance fallen by the mass, ‘y’, is given by (x * tangent(a)), where ‘x’ was measured in step C1. Again, for these calculations, tangent works on degrees.

(FIGS. 7d and 1) attach one synchronization plug 111 from the pendulum timer 100 to the synchronization socket (709).

Click the pulley brake release handle (702) to allow the more massive mass to fall.

The timer 100 starts when the brake 702 is released and stops when the mass reaches its lowest position (710).

Now that the masses, falling distance, and falling time are known, gravity can be calculated by (g=(2y/tˆ 2)*(m2+m1)/(m2−m1)), where ‘y’ was calculated in step C4, ‘t’ is the time measured in step F, m2 is the mass of the heavier mass, and m1 is the mass of the lighter mass measured in step A.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A computer program executable on a computer having a processor, a display, a keyboard, and a mouse, for graphically simulating a variety of physical measuring instruments on the display.

2. The computer program of claim 1, wherein the program graphically simulates measuring instruments selected from the group consisting of a pendulum timer, a balance, a tape measure, a surveyor tool, and an object launcher.

3. The computer program of claim 1, wherein the measuring instruments can be repositioned on the display by clicking and dragging them with the mouse.

4. The computer program of claim 2, wherein the pendulum timer is measured by simulated falling marbles.

5. The computer program of claim 2, wherein the pendulum timer may be started and stopped by another simulated measuring instrument.

6. The computer program of claim 5, the pendulum timer further comprising a synchronization plug and another simulated measuring instrument having a synchronization socket receiving the synchronization plug.

7. The computer program of claim 6, wherein the synchronization plug may be moved to the synchronization socket by clicking and dragging it with the mouse.

8. The computer program of claim 2, wherein the balance further comprises a two-pan balance with a set of standard masses.

9. The computer program of claim 8, wherein the balance weighs an object automatically by placing the object in one of the pans and weighing the object serially against each mass from the set of standard masses.

10. The computer program of claim 8, wherein the set of standard masses comprises a plurality of masses with weights related to one another by a power of two.

11. The computer program of claim 2, wherein the tape measure further comprises a housing with an extendable and retractable tape therein.

12. The computer program of claim 2, wherein the surveyor instrument further comprises a control panel, a laser/rangefinder, and a tripod, the tripod having a head, the laser/rangefinder resting on the tripod head, the tripod being adjustable in height, the laser/rangefinder being positionable at a plurality of angles relative to the display.

13. The computer program of claim 12, the control panel further comprising an angle scale showing the position of the laser/rangefinder relative to the display, a distance scale showing the distance from the laser/rangefinder to a target object, and a height slider for adjusting the height of the tripod head.

14. The computer program of claim 13, the control panel further comprising a laser operation light and a rangefinder operation light.

15. The computer program of claim 13, wherein the laser/rangefinder projects a laser beam that gives a visual representation of the point on the target object at which the laser/rangefinder is aimed.

16. The computer program of claim 2, wherein the object launcher further comprises a launcher head, a tripod, an angle scale, and a velocity control, the object launcher being positionable at a plurality of angles relative to the display and the initial velocity of objects launched by the launcher head being indicated by the velocity control.

17. A method for graphically simulating a variety of physical measuring instruments on a display, comprising the steps of:
(a) displaying the simulated physical measuring instruments as icons on a display;
(b) waiting for the operator to select an icon;
(c) activating the simulated physical measuring instrument corresponding to the user-selected icon;
(d) applying a simulated force to the active simulated physical measuring instrument; and
(e) monitoring changes in the active simulated physical measuring instrument as a result of the simulated applied force.

18. The method of claim 17, wherein a simulated game character applies the force.

19. The method of claim 17, wherein the simulated measuring instruments are selected from the group consisting of a pendulum timer, a balance, a tape measure, a surveyor tool, and an object launcher.

20. The method of claim 17, wherein the measuring instruments can be repositioned on the display by clicking and dragging them with a mouse.

21. The method of claim 19, wherein the pendulum timer is measured by simulated falling marbles.

22. The method of claim 19, wherein the pendulum timer may be started and stopped by another simulated measuring instrument.

23. The method of claim 22, the pendulum timer further comprising a synchronization plug and another simulated measuring instrument having a synchronization socket receiving the synchronization plug.

24. The method of claim 23, wherein the synchronization plug may be moved to the synchronization socket by clicking and dragging it with a mouse.

25. The method of claim 19, wherein the balance further comprises a two-pan balance with a set of standard masses.

26. The method of claim 19, further comprising the step of weighing an object automatically by placing the object in one of the pans and weighing the object serially against each mass from the set of standard masses.

27. The method of claim 26, wherein the set of standard masses comprises a plurality of masses with weights related to one another by a power of two.

28. The method of claim 19, wherein the tape measure further comprises a housing with an extendable and retractable tape therein.

29. The method of claim 19, wherein the surveyor instrument further comprises a control panel, a laser/rangefinder, and a tripod, the tripod having a head, the laser/rangefinder resting on the tripod head, the tripod being adjustable in height, the laser/rangefinder being positionable at a plurality of angles relative to the display.

30. The method of claim 29, the control panel further comprising an angle scale showing the position of the laser/rangefinder relative to the display, a distance scale showing the distance from the laser/rangefinder to a target object, and a height slider for adjusting the height of the tripod head.

31. The method of claim 29, the control panel further comprising a laser operation light and a rangefinder operation light.

32. The method of claim 30, wherein the laser/rangefinder projects a laser beam that gives a visual representation of the point on the target object at which the laser/rangefinder is aimed.

33. The method of claim 19, wherein the object launcher further comprises a launcher head, a tripod, an angle scale, and a velocity control, the object launcher being positionable at a plurality of angles relative to the display and the initial velocity of objects launched by the launcher head being indicated by the velocity control.

34. A computer game constructed using the method of claim 19, wherein the object of the game is to measure and interact with a simulated environment for the purpose of moving a game character through the simulated environment and extracting information from the simulated environment.

35. A computer game constructed using the method of claim 19, wherein the object of the game is to construct a graphic structure by using the object launcher to fire objects from one position to another position on the display at a particular angle and velocity, and wherein the angle and velocity are determined using the simulated physical measuring instruments.
